(19) United States
(12) Patent Application Publication
(10) Pub. No.: US 2002/0016728 A1
(43) Pub. Date: Feb. 7, 2002

(54) Temporary worker information management system, temporary worker information management method, dispatching terminal, job offer terminal, dispatching information server, and recording medium

(75) Inventors: Koichi Toyoda, Tokyo (JP); Ryosuke Gion, Hyogo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/873,217

(22) Filed: Jun. 5, 2001

(30) Foreign Application Priority Data
Jun. 6, 2000 (JP) 2000-168516

(51) Int. Cl. G06F 17/60

(52) U.S. Cl. 705/9

(57) ABSTRACT

Information that is required to dispatch human resources between organizations in a company or between organizations in companies that cooperate with each other can be registered efficiently. When a dispatchable temporary worker occurs, dispatchable temporary worker information representing the skill of the dispatchable temporary worker, etc., is transmitted from a dispatching terminal to a dispatching information server. When a need for a temporary worker arises, job offer information representing a desired skill for the temporary worker, etc., is transmitted from a job offer terminal to the dispatching information server. The dispatching information server registers the dispatchable temporary worker information from the dispatching terminal therein. If the job offer information registered in the dispatching information server includes information that matches the dispatchable temporary worker information, the dispatching information server transmits the dispatchable temporary worker information to the job offer terminal which has registered the matching job offer information. The dispatching information server registers job offer information from the job offer terminal therein. If the dispatchable temporary worker information registered in the dispatching information server includes information that matches the job offer information, then the dispatching information server transmits the matching dispatchable temporary worker information to the dispatching terminal.

### BACKGROUND OF THE INVENTION

1. Field of the Invention

The present invention relates to the art of temporary worker information management, and more particularly to a temporary worker information management technology for the effective utilization of human resources within companies or between companies that cooperate with each other.

2. Description of the Related Art

One example of a temporary worker information management system which uses a computer is disclosed in Japanese laid-open patent publication No. 11-39392. The disclosed temporary worker information management system is applicable to temporary worker agencies outside of companies and the services of dispatching temporary workers in temporary worker departments in companies. As shown in FIG. 1 of the accompanying drawings, the disclosed temporary worker information management system comprises working period information inputting means 1, temporary worker request information inputting means 2, temporary worker assigning means 3, and wage processing means 4. The conventional temporary worker information management system thus constructed operates as follows:

Working period information inputting means 1 enters working period information of each temporary worker. Temporary worker request information inputting means 2 enters temporary worker request information including at least the working period of a temporary worker.

Temporary worker assigning means 3 searches the working period information already entered from working period information inputting means 1 for working period information that satisfies conditions represented by the temporary worker request information entered from temporary worker request information inputting means 2, and assigns a corresponding temporary worker. Wage processing means 4 performs wage processing on the temporary worker assigned by temporary worker assigning means 3, based on the information of the working period entered from temporary worker request information inputting means 2.

The conventional temporary worker information management system is installed in a certain location, and the system administrator needs to enter working period information, etc., required to dispatch temporary workers, using working period information inputting means 1 and temporary worker request information inputting means 2. Therefore, the conventional temporary worker information management system may not be suitable for managing information that is required to dispatch human resources between organizations in a company, e.g., divisions, departments, or sections, or between organizations in companies that cooperate with each other. Specifically, since organizations in a company or organizations in companies that cooperate with each other are usually scattered around the country, if information required to dispatch temporary workers is to be registered, then a person in charge in such an organization requests the system administrator to register the information over the telephone, facsimile, or the like, and the requested system administrator registers the information using working period information inputting means 1 and temporary worker request information inputting means 2. Therefore, the registering process is tedious, time-consuming, and cannot be performed efficiently.

The conventional temporary worker information management system is also disadvantageous in that it cannot quickly determine a temporary worker to be dispatched because the working period information already entered from working period information inputting means 1 is searched for working period information that satisfies conditions represented by the temporary worker request information in order to determine such a temporary worker. Specifically, since no search is carried out at the time working period information that satisfies conditions represented by the temporary worker request information that has already been entered is subsequently entered, a temporary worker to be dispatched cannot occasionally be determined quickly.

### SUMMARY OF THE INVENTION

It is an object of the present invention to provide a temporary worker information management system which employs a computer system that is capable of efficiently registering information that is required to dispatch a temporary worker between organizations in a company or between organizations in companies that cooperate with each other, and is also capable of allowing a job offerer to know the registration of a temporary worker that satisfies job offer conditions immediately when the temporary worker is registered.

In order to achieve the above object, there is provided in accordance with the present invention a temporary worker information management system comprising a network, a dispatching terminal connected to the network, a job offer terminal connected to the network, and a dispatching information server connected to the network.

The dispatching terminal comprises means for transmitting dispatchable temporary worker information representing the number of dispatchable temporary workers, a skill thereof, and a dispatchable period, which have been entered, to the dispatching information server when a dispatchable temporary worker occurs in an organization, and means for displaying job offer information representing the desired number of dispatched temporary workers, a desired skill thereof, and a desired dispatching period, transmitted from the dispatching information server;

The job offer terminal comprises means for transmitting job offer information representing the number of temporary workers desired to be dispatched, a skill thereof, and a desired dispatching period, which have been entered, to the dispatching information server when a request for a temporary worker occurs, and

means for displaying dispatchable temporary worker information transmitted from the dispatching information server;

The dispatching information server comprises means for registering dispatchable temporary worker information transmitted from the dispatching terminal, means for registering job offer information transmitted from the job offer terminal, means for searching job offer information registered therein when dispatchable temporary worker information is transmitted from the dispatching terminal, and, if there is job offer information that matches the dispatchable temporary worker information, transmitting the dispatchable temporary worker information to the job offer terminal which has registered the matching job offer information, and means for searching dispatchable temporary worker information registered therein when job offer information is transmitted from the job offer terminal, and, if there is dispatchable temporary worker information that matches the job offer information, transmitting the matching dispatchable temporary worker information to the job offer terminal.

With this arrangement, if the dispatching terminal and the job offer terminal are installed in each of organizations in a company or each of organizations in companies that cooperate with each other, information that is required for dispatching human resources can be registered in the dispatching information server from each of the organizations. Therefore, such information can be registered more efficiently than with conventional systems.

When dispatchable temporary worker information is transmitted from the dispatching terminal, job offer information registered in the dispatching information terminal is searched. If there is job offer information that matches the dispatchable temporary worker information, then the dispatchable temporary worker information is transmitted to the job offer terminal that has registered the matching job offer information. Therefore, if dispatchable temporary worker information that satisfies conditions given by a job offerer is registered, the job offerer can immediately recognize the registration of the dispatchable temporary worker information.

In order for the temporary worker information management system to be able to manage an evaluation of the skill of temporary workers dispatched to a temporary worker recipient, the job offer terminal may further include means for transmitting an entered evaluation report on an evaluation of the skill of a dispatched temporary worker to the dispatching information server, means for transmitting an entered dispatching contract evaluation information referring request to the dispatching information server, and means for displaying dispatching contract evaluation information transmitted from the dispatching information server.

The dispatching terminal may further include means for transmitting an entered dispatching contract evaluation information referring request to the dispatching information server, and means for displaying dispatching contract evaluation information transmitted from the dispatching information server; and

The dispatching information server may further include means for generating dispatching contract evaluation information which reflects details of an evaluation report transmitted from the job offer terminal, registering the generated dispatching contract evaluation information therein, and transmitting the generated dispatching contract evaluation information to the dispatching terminal, and means responsive to dispatching contract evaluation information referring requests transmitted from the dispatching terminal and the job offer terminal, for transmitting dispatching contract evaluation information registered in the dispatching information server to the dispatching terminal and the job offer terminal.

In addition, in order to prevent unauthorized use of the temporary worker information management system, user information may be registered in the dispatching information server in advance, and a user may be authenticated based on the registered user information when the dispatching information server is logged in.

In order for users to pay the operating cost of the temporary worker information management system on a fair basis, each of a temporary worker dispatcher and a temporary worker recipient may pay a fixed membership fee and a predetermined ratio of a dispatching cost to an administrator of the dispatching information server.

The above and other objects, features, and advantages of the present invention will become apparent from the following descriptions based on the accompanying drawings which illustrate an example of a preferred embodiment of the present invention.

### BRIEF DESCRIPTION OF THE DRAWINGS

FIG. 1 is a block diagram of a conventional temporary worker information management system;

FIG. 2 is a block diagram of a temporary worker information management system according to the present invention;

FIG. 3 is a flowchart of a processing sequence for registering user information;

FIG. 4 is a flowchart of a processing sequence for registering a dispatchable temporary worker;

FIG. 5 is a flowchart of a processing sequence for registering job offer information;

FIG. 6 is a flowchart of a processing sequence for entering temporary worker dispatching contract information;

FIG. 7 is a flowchart of a processing sequence for entering an evaluation report;

FIG. 8 is a flowchart of a processing sequence for referring to dispatching contract evaluation information;

FIG. 9 is a flowchart of a processing sequence for searching for dispatchable temporary worker information;

FIG. 10 is a flowchart of a processing sequence for searching for job offer information;

FIG. 11 is a diagram showing an example of user information registered in a temporary worker information server;

FIG. 12 is a diagram showing an example of dispatchable temporary worker information registered in the temporary worker information server;

FIG. 13 is a diagram showing an example of skill evaluation standards;

FIG. 14 is a diagram showing an example of job offer information registered in the temporary worker information server; and

FIG. 15 is a diagram showing an example of dispatching contract evaluation information.

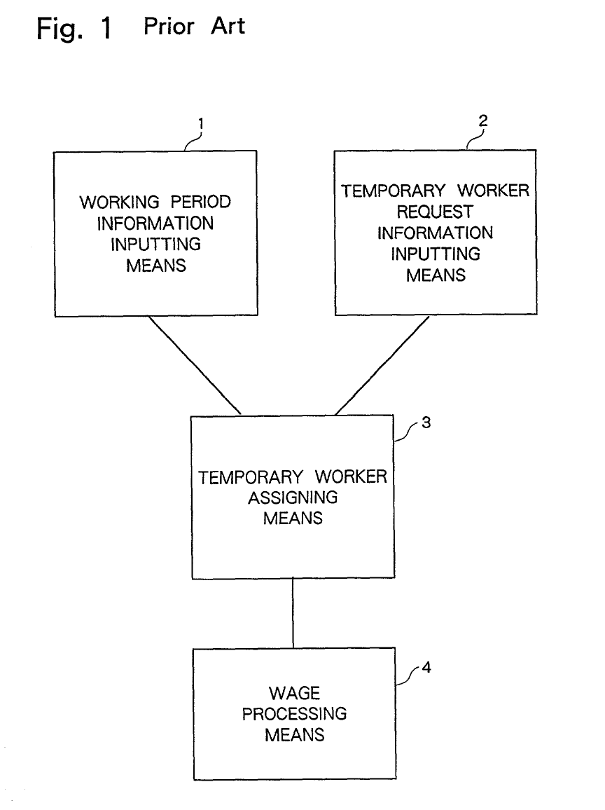

### DETAILED DESCRIPTION OF THE PREFERRED EMBODIMENT

A preferred embodiment of the present invention will be described in detail below with reference to the drawings.

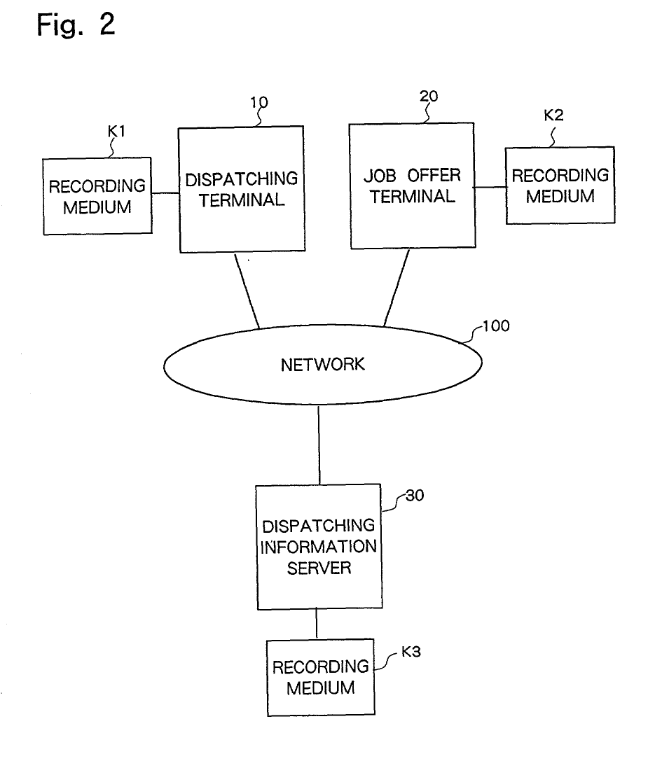

As shown in FIG. 2, a temporary worker information management system according to the present invention comprises dispatching terminal 10, job offer terminal 20, dispatching information server 30, and network 100 such as the Internet or the like which interconnects with dispatching terminal 10, job offer terminal 20, and dispatching information server 30.

Dispatching terminal 10 comprises an information processing device such as a personal computer or the like. Dispatching terminal 10 has a function to transmit user information, which has been input to apply for the use of the temporary worker information management system from an input device (not shown) by a registering clerk in an organization (a division, a department, or a section) where dispatching terminal 10 is located, to dispatching information server 30, a function to transmit dispatchable temporary worker information, which has been input from the input device by the registering clerk when a dispatchable temporary worker becomes available (as when there is an excess worker in the organization), to dispatching information server 30, and a function to display job offer information sent from dispatching information server 30 on a display device (not shown).

The user information to be transmitted from dispatching terminal 10 includes a password, a company name, an organization name, a registrant's name, a registrant's mail address, etc. The dispatchable temporary worker information includes a registrant's ID, a dispatchable period, the number of dispatchable temporary workers, technical skill levels of dispatchable temporary workers, etc.

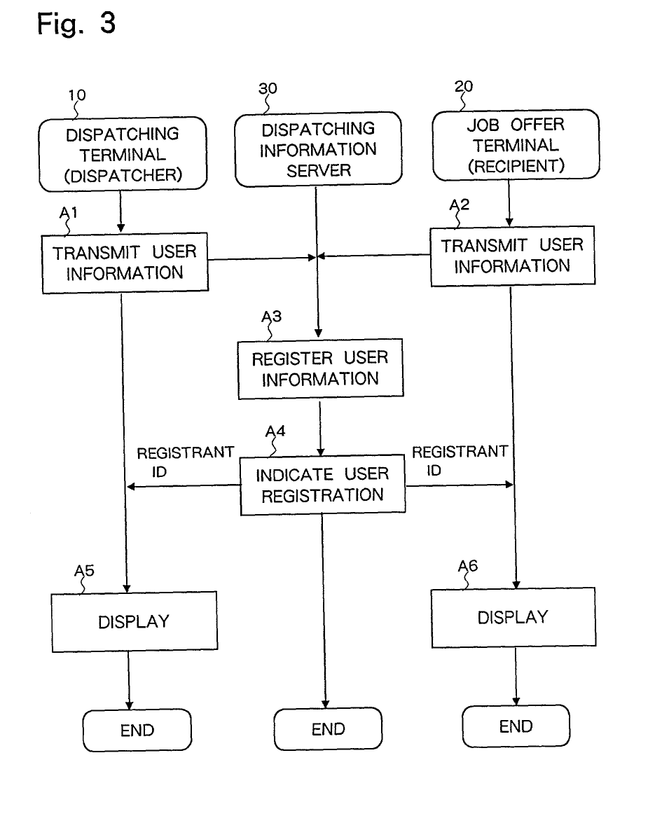

Dispatching terminal 10 has a recording medium K1 such as a disk, a semiconductor memory, or any of various other recording mediums, which stores a program for enabling a computer to function as dispatching terminal 10. The stored program is read by the computer and controls operation of the computer to enable the computer to perform processing sequences shown in FIGS. 3 through 7 and 10. While only one dispatching terminal 10 is shown in FIG. 2, a plurality of temporary worker dispatching terminals are actually connected to network 100.

Job offer terminal 20 comprises an information processing device such as a personal computer or the like. Job offer terminal 20 has a function to transmit user information, which has been input to apply for the use of the temporary worker information management system from an input device (not shown) by a registering clerk in an organization (a division, a department, or a section) where job offer terminal 20 is located, to the dispatching information server 30, a function to transmit job offer information, which has been input from the input device by the registering clerk, when it is necessary to have a temporary worker as when a project occurs, and a function to display dispatchable temporary worker information sent from dispatching information server 30 on a display device (not shown).

The user information to be transmitted from job offer terminal 20 includes a password, a company name, an organization name, a registrant's name, a registrant's mail address, etc. The job offer information includes a registrant's ID, a desired dispatching period, the number of temporary workers desired to be dispatched, technical skill levels required of temporary workers, etc.

Job offer terminal 20 has a recording medium K2 such as a disk, a semiconductor memory, or any of various other recording mediums, which stores a program for enabling a computer to function as job offer terminal 20. The stored program is read by the computer and controls operation of the computer to enable the computer to perform processing sequences shown in FIGS. 3 through 9. While only one job offer terminal 20 is shown in FIG. 2, a plurality of job offer terminals are actually connected to network 100.

Dispatching information server 30 is implemented by a computer. Dispatching information server 30 has a function to register dispatchable temporary worker information transmitted from dispatching terminal 10 in a dispatchable temporary worker table (not shown) stored in a memory in dispatching information server 30, and a function to register job offer information transmitted from job offer terminal 20 in a job offer table (not shown) in a memory in dispatching information server 30.

Dispatching information server 30 also has a function to search the job offer information registered in the job offer table when dispatchable temporary worker information is transmitted from dispatching terminal 10, and, if there is job offer information that matches the dispatchable temporary worker information, to transmit the matching job offer information to dispatching terminal 10 which has registered the dispatchable temporary worker information, and also transmit the dispatchable temporary worker information to job offer terminal 20 which has registered the matching job offer information.

Dispatching information server 30 also has a function to search the dispatchable temporary worker information registered in the dispatchable temporary worker table when job offer information is transmitted from job offer terminal 20, and, if there is dispatchable temporary worker information that matches the job offer information, to transmit the matching dispatchable temporary worker information to job offer terminal 20 which has registered the job offer information, and also transmit the job offer information to dispatching terminal 10 which has registered the matching dispatchable temporary worker information.

Dispatching information server 30 has a recording medium K3 such as a disk, a semiconductor memory, or any of various other recording mediums, which stores a program for enabling a computer to function as dispatching information server 30. The stored program is read by the computer and controls operation of the computer to enable the computer to perform processing sequences shown in FIGS. 3 through 10.

Operation of the temporary worker information management system will be described in detail below.

First, a process of applying for the use of the temporary worker information management system will be described below. For using the temporary worker information management system, a registering clerk in an organization where dispatching terminal 10 is located, e.g., a representative of the organization or the like, connects dispatching terminal 10 to dispatching information server 30, and enters user information including a password by choice, a company name, an organization name, a registrant's name, a registrant's mail address, etc. Dispatching terminal 10 transmits the entered user information via the network 100 to dispatching information server 30 in step A1 shown in FIG. 3.

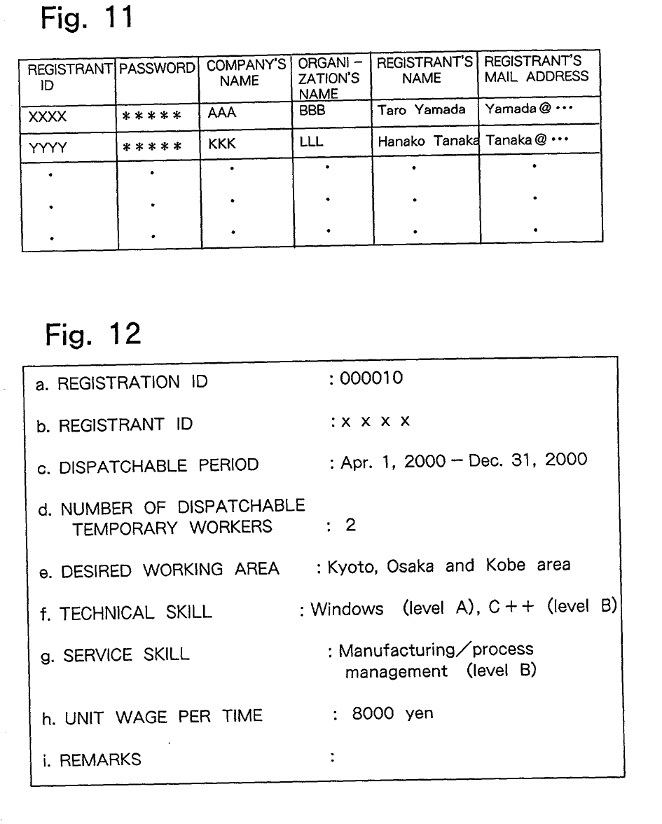

When the user information is transmitted from dispatching terminal 10 to dispatching information server 30, the administrator of dispatching information server 30 inspects the user information. If the administrator finds no problem in the user information, then the administrator registers the user information in step A3. At this time, dispatching information server 30 assigns a unique registrant ID to the user information, and registers the registrant ID and the user information as paired with each other in the memory, as shown in FIG. 11. Thereafter, dispatching information server 30 transmits a mail message indicating that the user information has been registered to the registrant of the user information in step A4. Dispatching terminal 10 displays the transmitted mail message in step A5. The mail message contains the registrant ID assigned in step A3. The registering clerk at dispatching terminal 10 will subsequently use the registrant ID for registering dispatchable temporary worker information, etc. The mail message may also contain a bill for an annual fee. When the user information is registered in step A3, the year, month, and day of the registration may also be registered, and a bill for an annual fee may be transmitted annually based on the registered year, month, and day.

When a registering clerk in an organization where job offer terminal 20 is located, e.g., a representative of the organization or the like, enters user information to apply for the use of the temporary worker information management system, the same process as described above is carried out in steps A2 through A4, A6.

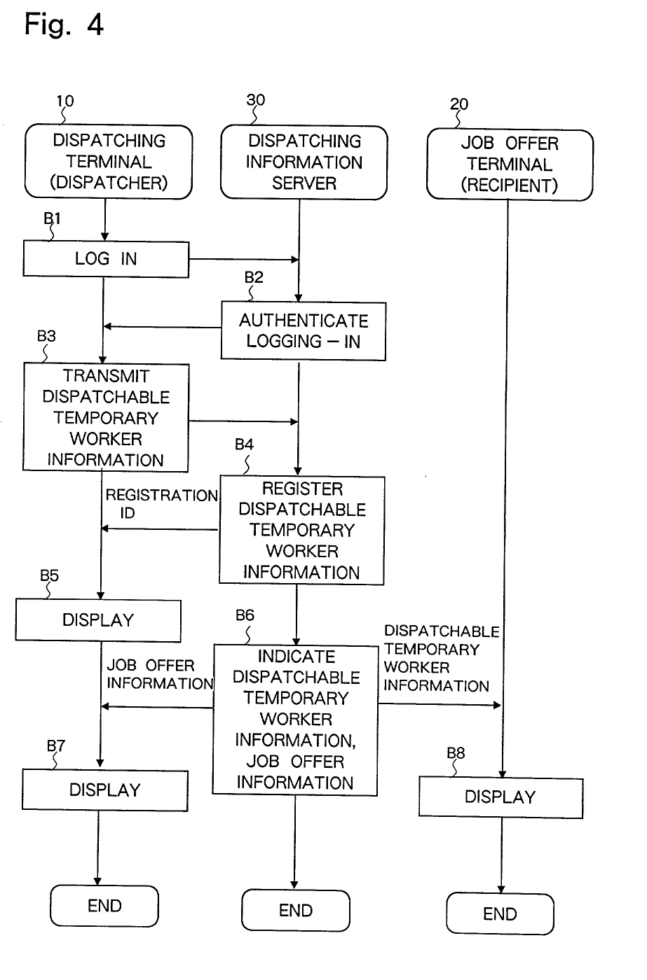

A process of registering dispatchable temporary worker information will be described below. The registering clerk at dispatching terminal 10 first connects dispatching terminal 10 to dispatching information server 30, and enters a registrant ID and a password in a log-in image. Dispatching terminal 10 transmits the registrant ID and the password that have been entered to dispatching information server 30 in step B1 shown in FIG. 4.

Dispatching information server 30 checks whether the registrant ID and the password that have been transmitted from dispatching terminal 10 are correct or not, based on the registrant ID and the password that were entered when the user information was registered. If the registrant ID and the password that have been transmitted from dispatching terminal 10 have no problem, then dispatching terminal 10 is allowed to use the temporary worker information management system in step B2.

When the temporary worker information management system becomes available for use, the registering clerk at dispatching terminal 10 enters dispatchable temporary worker information from the input device. Dispatching terminal 10 then transmits the entered dispatchable temporary worker information to dispatching information server 30 in step B3.

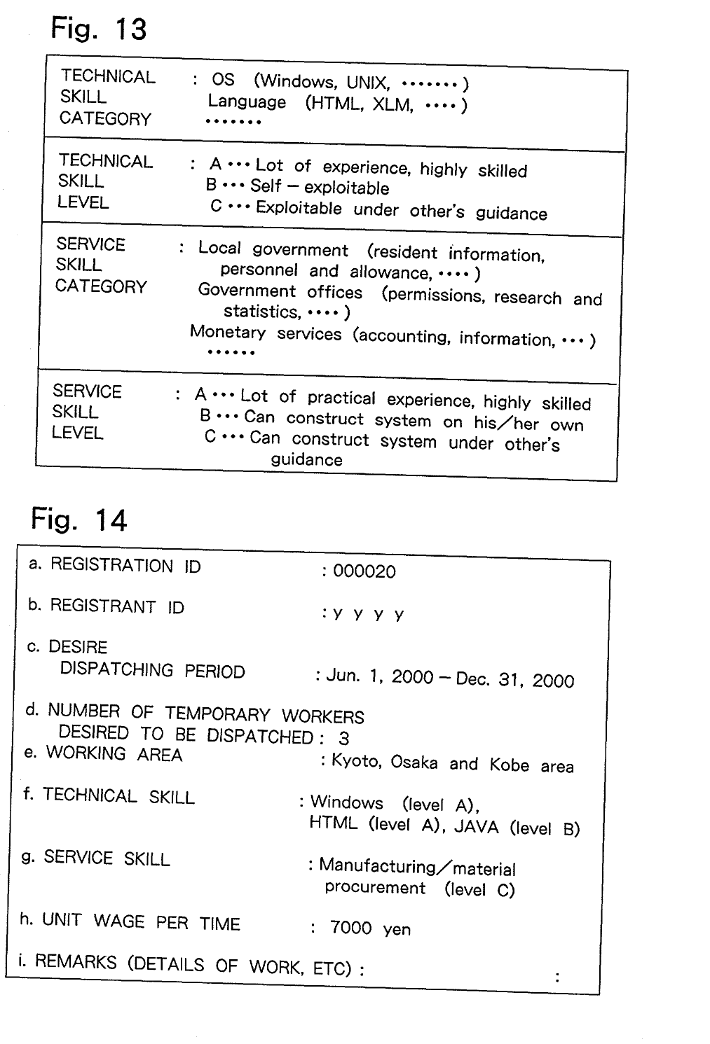

When the dispatchable temporary worker information is transmitted from dispatching terminal 10, dispatching information server 30 assigns a unique registration ID, e.g., a serial number, to the dispatchable temporary worker information, registers it in the memory, and transmits the registration ID to dispatching terminal 10 in step B4. FIG. 12 shows by way of example the dispatchable temporary worker information with the registration ID assigned thereto, which has been stored in the memory in step B4. The levels of technical and service skills of the dispatchable temporary worker information shown in FIG. 12 have been determined by an evaluator based on standards shown in FIG. 13. The registration ID transmitted to dispatching terminal 10 is displayed on the display device of dispatching terminal 10 in step B5.

Thereafter, dispatching information server 30 searches the job offer information already registered therein for job offer information that matches the dispatchable temporary worker information registered in step B4. If dispatching information server 30 finds no matching job offer information, then the processing sequence is ended. If dispatching information server 30 finds matching job offer information, then dispatching information server 30 transmits the found job offer information to dispatching terminal 10 which has registered the dispatchable temporary worker information, and transmits a mail message containing the dispatchable temporary worker information registered in step B4 to job offer terminal 20 which has registered the found job offer information in step B6. The mail address of job offer terminal 20 which has registered the job offer information can be known by searching the user information using the registrant ID contained in the job offer information as a key. In the present embodiment, the job offer information that satisfies the following conditions a through e is determined as job offer information that matches the dispatchable temporary worker information.

a. The desired dispatching period falls in the dispatchable period.

b. The difference between the number of dispatchable temporary workers and the number of temporary workers desired to be dispatched falls in a predetermined number.

c. The desired working area is in agreement with the working place.

d. Both the dispatchable temporary worker information and the job offer information contain common technical and service skill categories and common technical and service skill levels are mutually agreeable.

e. The difference between unit wages per time falls in a predetermined value.

When the job offer information is transmitted from dispatching information server 30, dispatching terminal 10 displays the transmitted job offer information on the display device thereof in step B7. When the dispatchable temporary worker information is transmitted from dispatching information server 30, job offer terminal 20 displays the transmitted dispatchable temporary worker information on the display device thereof in step B8.

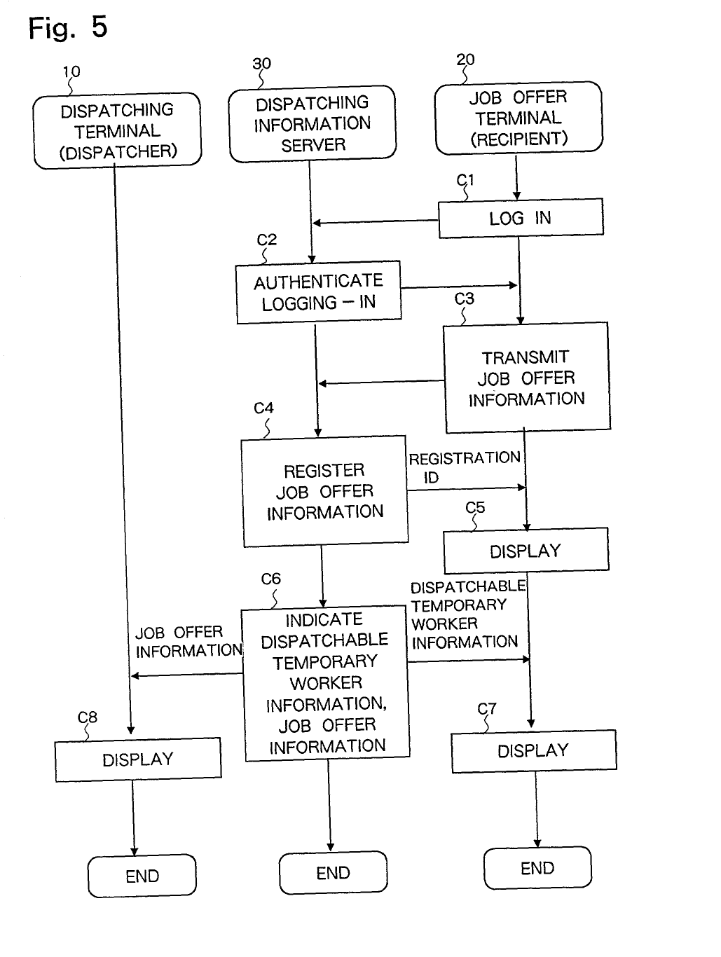

A process of registering job offer information will be described below. When the registering clerk at job offer terminal 20 is successful in logging in steps C1, C2 shown in FIG. 5, the person enters job offer information from the input device into job offer terminal 20. Job offer terminal 20 then transmits the entered job offer information to dispatching information server 30 in step C3.

When the job offer information is transmitted from job offer terminal 20, dispatching information server 30 assigns a unique registration ID to the job offer information, registers it in the memory, and transmits the registration ID to job offer terminal 20 in step C4. FIG. 14 shows by way of example the job offer information with the registration ID assigned thereto, which has been stored in the memory in step C4. The registration ID transmitted to job offer terminal 20 is displayed on the display device of job offer terminal 20 in step C5.

Thereafter, dispatching information server 30 searches the dispatchable temporary worker information already registered therein for dispatchable temporary worker information that matches the job offer information registered in step C4. If dispatching information server 30 finds no matching dispatchable temporary worker information, then the processing sequence is put to an end. If dispatching information server 30 finds matching dispatchable temporary worker information, then dispatching information server 30 transmits the found dispatchable temporary worker information to job offer terminal 20 which has registered the job offer information, and transmits a mail message containing the job offer information registered in step C4 to dispatching terminal 10 which has registered the found dispatchable temporary worker information in step C6. The mail address of dispatching terminal 10 which has registered the dispatchable temporary worker information can be known by searching the user information using the registrant ID contained in the dispatchable temporary worker information as a key. In the present embodiment, the dispatchable temporary worker information that satisfies the following conditions f through j is determined as dispatchable temporary worker information that matches the job offer information.

f. The desired dispatching period falls in the dispatchable period.

g. The difference between the number of dispatchable temporary workers and the number of temporary workers desired to be dispatched falls in a predetermined number.

h. The desired working area is in agreement with the working place.

i. Both the dispatchable temporary worker information and the job offer information contain common technical and service skill categories and common technical and service skill levels are mutually agreeable.

j. The difference between unit wages per time falls in a predetermined value.

When the dispatchable temporary worker information is transmitted from dispatching information server 30, job offer terminal 20 displays the transmitted dispatchable temporary worker information on the display device thereof in step C7. When the job offer information is transmitted from dispatching information server 30, dispatching terminal 10 displays the transmitted job offer information on the display device thereof in step C8.

If there is satisfying dispatchable temporary worker information in the dispatchable temporary worker information transmitted from dispatching information server 30, then a job offer clerk in the organization where job offer terminal 20 is installed transmits the registrant ID contained in the dispatchable temporary worker information to dispatching information server 30 in order to know the mail address of the registrant of the satisfying dispatchable temporary worker information. In response to the registrant ID transmitted from job offer terminal 20, dispatching information server 30 searches the registered user information (see FIG. 11), acquires the mail address registered in association with the registrant ID, and transmits the acquired mail address to job offer terminal 20. Since the job offer clerk at job offer terminal 20 can communicate with the registrant of the satisfying dispatchable temporary worker information using the mail address, the job offer clerk can now negotiate and contract with the registrant of the dispatchable temporary worker information.

If there is satisfying job offer information in the job offer information transmitted from dispatching information server 30, then a dispatching clerk in the organization where dispatching terminal 10 is installed transmits the registrant ID contained in the job offer information to dispatching information server 30 in order to know the mail address of the registrant of the satisfying job offer information. In response to the registrant ID transmitted from dispatching terminal 10, dispatching information server 30 searches the registered user information, acquires the mail address of the registrant of the job offer information, and transmits the acquired mail address to dispatching terminal 10. The dispatching clerk at dispatching terminal 10 can now negotiate and contract with the registrant of the job offer information.

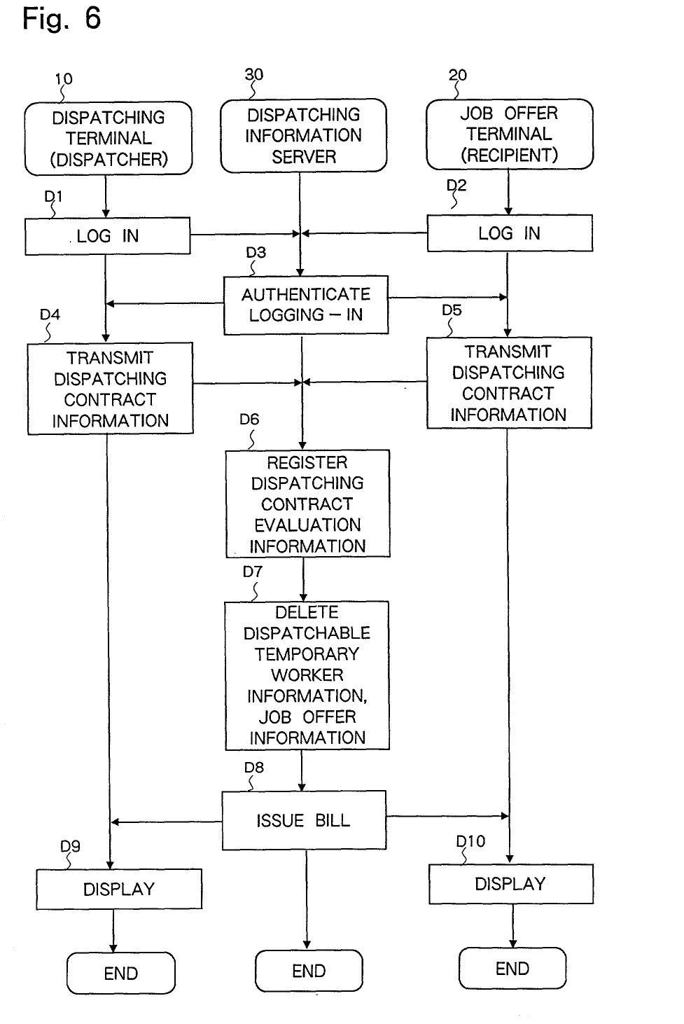

When the contract is concluded, the dispatching clerk at dispatching terminal 10 logs in dispatching information server 30 from dispatching terminal 10 in steps D1, D3 shown in FIG. 6. Then, the dispatching clerk enters dispatching contract information (dispatcher's dispatching contract information), which includes details (a dispatching period, the number of temporary workers, the working place, and the unit wage per time) of the contract, the registration ID of the dispatchable temporary worker information which has led to the contract, and the registration ID of the job offer information which has led to the contract, from the input device into dispatching terminal 10. Dispatching terminal 10 then transmits the entered dispatching contract information to dispatching information server 30 in step D4. Similarly, after the dispatching clerk at dispatching terminal 10 logs in dispatching information server 30 from job offer terminal 20 in steps D2, D3, the job offer clerk enters dispatching contract information (offerer's dispatching contract information) from the input device into job offer terminal 20. Job offer terminal 20 then transmits the entered offer's dispatching contract information to dispatching information server 30 in step D5.

When the dispatching contract information is transmitted from dispatching terminal 10 or job offer terminal 20, dispatching information server 30 performs the processing in step D6. The processing in step D6 will be described below.

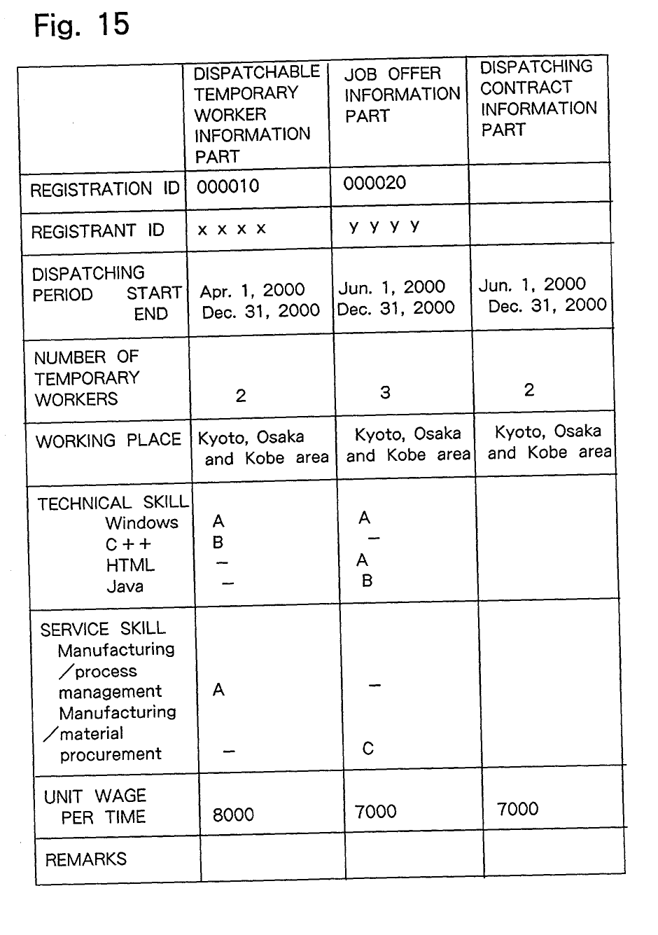

When the dispatcher's dispatching contract information is transmitted from dispatching terminal 10, dispatching information server 30 takes out two registration IDs contained in the transmitted dispatcher's dispatching contract information, and searches the offer's dispatching contract information that has already been transmitted from job offer terminal 20 and registered therein, for offerer's dispatching contract information that contains the two registration IDs. If dispatching information server 30 fails to find such offerer's dispatching contract information, then dispatching information server 30 registers the dispatcher's dispatching contract information transmitted from dispatching terminal 10 therein. If dispatching information server 30 finds the offerer's dispatching contract information containing the two registration IDS, then dispatching information server 30 checks if there is a match between the found offerer's dispatching contract information and the dispatcher's dispatching contract information transmitted from dispatching terminal 10. If there is no match, dispatching information server 30 indicates to dispatching terminal 10 and job offer terminal 20 that there is no match between the found offerer's dispatching contract information and the dispatcher's dispatching contract information, and deletes the found offerer's dispatching contract information. If there is a match, then dispatching information server 30 registers dispatching contract evaluation information as shown in FIG. 15, which includes the dispatching contract information (excluding the two registration IDs contained therein), the job offer information which has led to the contract indicated by the registration ID, and the dispatchable temporary worker information which has led to the contract indicated by the registration ID, in an evaluation information table (not shown) in dispatching information server 30. The data contained in the evaluation information table cannot be deleted. Thereafter, dispatching information server 30 deletes the offerer's dispatching contract information that has been presently processed from the offerer's dispatching contract information registered therein.

When the offerer's dispatching contract information is transmitted from job offer terminal 20, dispatching information server 30 takes out two registration IDs contained in the transmitted offerer's dispatching contract information, and searches the dispatcher's dispatching contract information that has already been transmitted from dispatching terminal 10 and registered therein, for dispatcher's dispatching contract information that contains the two registration IDs. If dispatching information server 30 fails to find such dispatcher's dispatching contract information, then dispatching information server 30 registers the offerer's dispatching contract information transmitted from job offer terminal 20 therein. If dispatching information server 30 finds the dispatcher's dispatching contract information containing the two registration IDS, then dispatching information server 30 checks if there is a match between the found dispatcher's dispatching contract information and the offerer's dispatching contract information transmitted from job offer terminal 20. Dispatching information server 30 then performs the same process as the process described above depending on the result of the check.

The processing in step D6 has been described above.

After step D6, dispatching information server 30 deletes the dispatchable temporary worker information and the job offer information that have been incorporated into the dispatching contract evaluation information in step D6, from the dispatchable temporary worker information and the job offer information that have been registered in the dispatchable temporary worker table and the job offer table in dispatching information server 30 in step D7. Thereafter, dispatching information server 30 transmits a bill with a charged amount of money that is proportional to the dispatching cost to dispatching terminal 10 and job offer terminal 20 in step D8. The transmitted bill is displayed on the display devices of dispatching terminal 10 and job offer terminal 20 in steps D9, D10. The dispatching cost is calculated based on the unit wage per time, the number of temporary workers, and the dispatching period that are contained in the dispatching contract information, for example, according to the formula represented by the unit wage per time×the number of temporary workers×the dispatching days×8 hours (the working time per day).

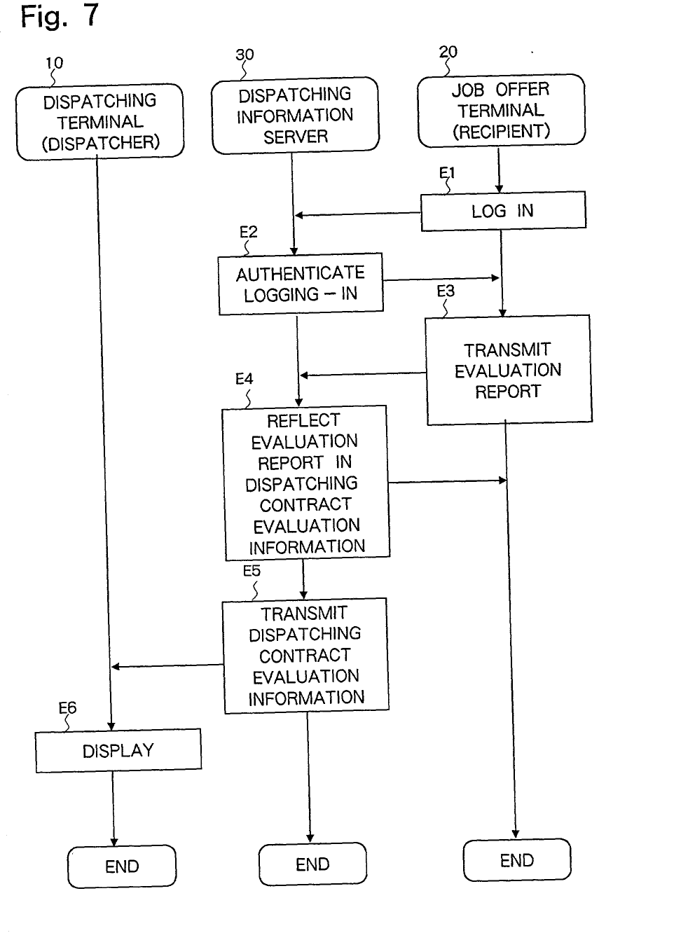

A process of registering an evaluation by the temporary worker recipient of the skill of a dispatched temporary worker after the elapse of the dispatching period will be described below. After an evaluator at job offer terminal 20 has logged in dispatching information server 30 from job offer terminal 20 in steps E1, E2 shown in FIG. 7, the evaluator enters a report on an evaluation of the skill of a dispatched temporary worker from the input device into job offer terminal 20. The evaluation report includes an evaluated level for a technical skill category evaluated by the evaluator and evaluated level for a service skill category evaluated by the evaluator. The evaluation report also includes the registration ID (e.g., 000010) of the dispatchable temporary worker information which has led to the contract, and the registration ID (e.g., 000020) of the job offer information which has led to the contract. Job offer terminal 20 transmits the entered evaluation report to dispatching information server 30 in step E3.

When the evaluation report is transmitted from job offer terminal 20, dispatching information server 30 takes out the two registration IDs (000010, 000020) from the transmitted evaluation report, and searches the dispatching contract evaluation information registered therein for dispatching contract evaluation information that contains the two registration IDs. As a result, the dispatching contract evaluation information shown in FIG. 15, for example, is found. Thereafter, dispatching information server 30 reflects the details of the evaluation report in the dispatching contract information part of the dispatching contract evaluation information shown in FIG. 15 in step E4, and then transmits a mail message containing the dispatching contract evaluation information which has reflected the details of the evaluation report to dispatching terminal 10 of the temporary worker dispatcher in step E5. The mail address of dispatching terminal 10 of the temporary worker dispatcher can be known by searching the user information registered in dispatching information server 30, based on the registrant ID “xxxx” in the dispatchable temporary worker information part. Dispatching terminal 10 displays the dispatching contract evaluation information transmitted from dispatching information server 30 on the display device in step E6.

A process of referring to the dispatching contract evaluation information registered in dispatching information server 30 from job offer terminal 20 will be described below.

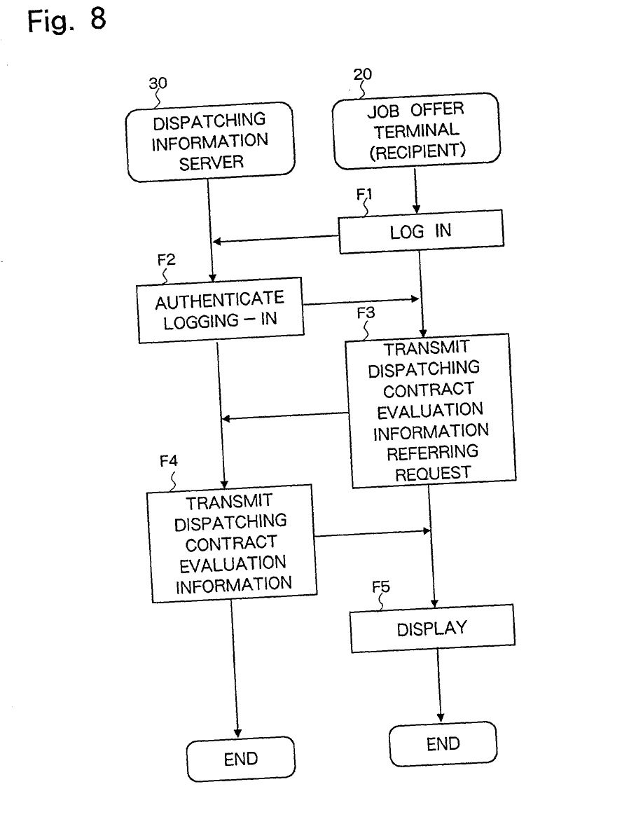

After the clerk at job offer terminal 20 has logged in dispatching information server 30 from job offer terminal 20 in steps F1, F2 shown in FIG. 8, the clerk enters a request for referring to the dispatching contract evaluation information from the input device into job offer terminal 20. Job offer terminal 20 then transmits the entered referring request to dispatching information server 30 in step F3. In response to the referring request, dispatching information server 30 transmits the dispatching contract evaluation information registered therein to job offer terminal 20 in step F4. Job offer terminal 20 then displays the transmitted dispatching contract evaluation information on the display device in step F5.

A process of referring to the dispatching contract evaluation information registered in dispatching information server 30 from dispatching terminal 10 is identical to the above referring process.

A process of searching for dispatchable temporary worker information registered in dispatching information server 30 from job offer terminal 20 will be described below.

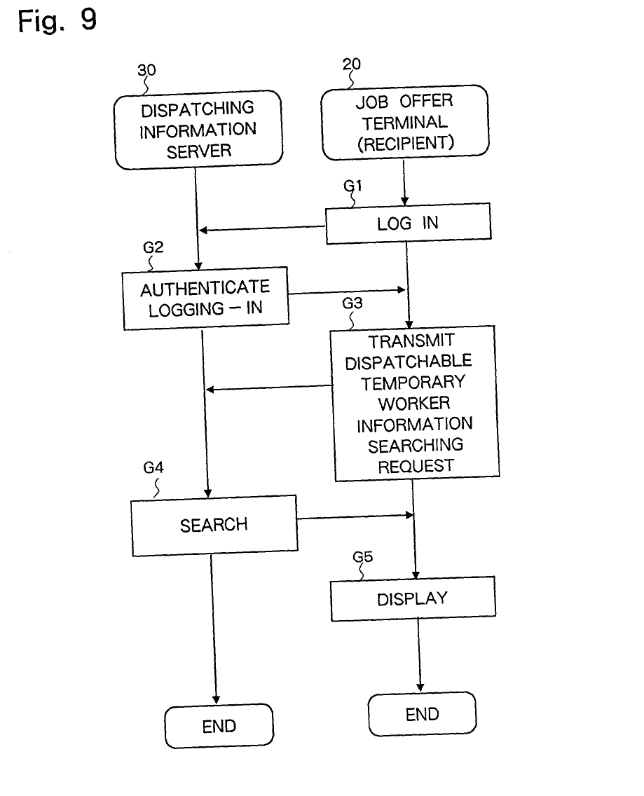

After the clerk at job offer terminal 20 has logged in dispatching information server 30 from job offer terminal 20 in steps G1, G2 shown in FIG. 9, the clerk enters a request for searching for dispatchable temporary worker information from the input device into job offer terminal 20. The searching request contains searching conditions including, for example, a dispatchable period, the number of dispatchable temporary workers, a desired dispatching area, a technical skill, a service skill, a unit wage per time, etc. Job offer terminal 20 transmits the searching request to dispatching information server 30 in step G3. Then, dispatching information server 30 searches the dispatchable temporary worker information registered therein for dispatchable temporary worker information that satisfies the searching conditions, and transmits the found dispatchable temporary worker information to job offer terminal 20 in step G4. Job offer terminal 20 displays the dispatchable temporary worker information transmitted from dispatching information server 30 on the display device in step G5.

A process of searching for job offer information registered in dispatching information server 30 from dispatching terminal 10 will be described below.

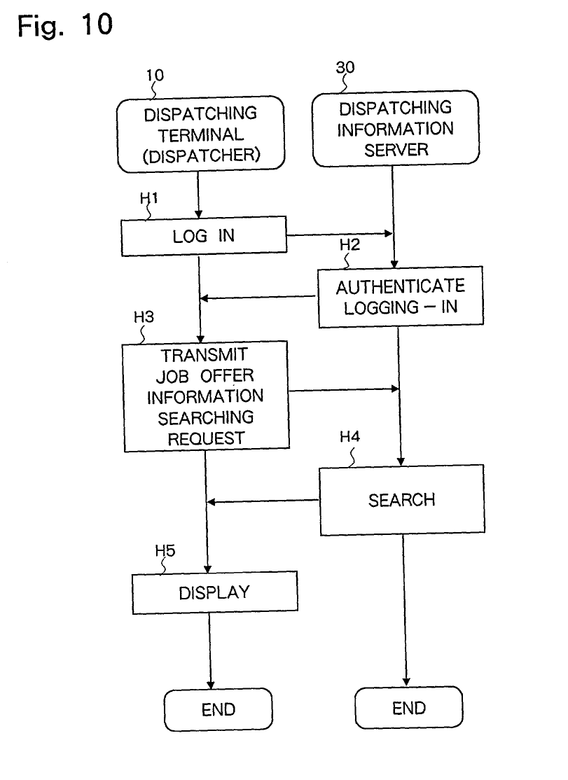

After the clerk at dispatching terminal 10 has logged in dispatching information server 30 from dispatching terminal 10 in steps H1, H2 shown in FIG. 10, the clerk enters a request for searching for job offer information from the input device into dispatching terminal 10. The searching request contains searching conditions including, for example, a dispatchable period, the number of temporary workers to be dispatched, a working place, a technical skill, a service skill, a unit wage per time, etc. Dispatching terminal 10 transmits the searching request to dispatching information server 30 in step H3. Then, dispatching information server 30 searches the job offer information registered therein for job offer information that satisfies the searching conditions, and transmits the found job offer information to dispatching terminal 10 in step H4. Dispatching terminal 10 displays the job offer information transmitted from dispatching information server 30 on the display device in step H5.

The present invention offers various advantages as described below.

The first advantage is that information that is required to dispatch human resources between organizations in a company or between organizations in companies that cooperate with each other can be registered efficiently. This is because the dispatching terminal, the job offer terminal, and the dispatching information server are connectable to each other via the network, allowing organizations in a company or organizations in companies that cooperate with each other, which are usually scattered around the country, to directly register information needed to dispatch human resources in the dispatching information server using the dispatching terminal and the job offer terminal.

The second advantage is that when a dispatchable temporary worker that satisfies job offer conditions is registered, a job offerer can immediately be aware of the registration of the satisfying dispatchable temporary worker. This is because when dispatchable temporary worker information is transmitted from the dispatching terminal to the dispatching information server, the job offer information registered in the dispatching information server is searched, and if there is job offer information matching the dispatchable temporary worker information, then the dispatchable temporary worker information is transmitted to the job offer terminal which has registered the job offer information.

The third advantage is that the evaluation of the skill of a dispatched temporary worker at the temporary worker recipient can be managed. This is because when a report on an evaluation of the dispatched temporary worker is transmitted from the job offer terminal, the dispatching information server registers dispatching contract evaluation information reflecting the details of the evaluation report therein.

By managing information that is required to dispatch human resources between organizations in a company or between organizations in companies that cooperate with each other, using the dispatched temporary worker skill information having the above first through third advantages, the following fourth through eleventh advantages can be expected to occur.

The fourth advantage is that it is possible for companies to hold skilled human resources according to their long-term business strategies in the environment of rapidly changing business structures.

The fifth advantage is that more stable employment can be achieved in the entire society.

The sixth advantage is that human resources needed for a short-term project can be supplied within a group of companies or from partner companies.

The seventh advantage is that know-how is prevented from leaking out of a group of cooperating companies or partner companies.

The eighth advantage is that human resources required by a group of companies or partner companies can adequately be grasped.

The ninth advantage is that the skill of employees and organizations of a company can properly be recognized from an evaluation made by a temporary worker recipient such as another company or department.

The tenth advantage is that a personnel department or the like is capable of continuously following the status of the skill of employees.

The eleventh advantage is that employees dispatched as temporary workers are better motivated by a proper evaluation of their skill during the temporary work.

It is to be understood, however, that although the characteristics and advantages of the present invention have been set forth in the foregoing description, the disclosure is illustrative only, and changes may be made in the arrangement of the parts within the scope of the appended claims.

What is claimed is:

1. A temporary worker information management system comprising a network, a dispatching terminal connected to the network, a job offer terminal connected to the network, and a dispatching information server connected to the network,
said dispatching terminal comprising:
means for transmitting dispatchable temporary worker information representing the number of dispatchable temporary workers, a skill thereof, and a dispatchable period, which have been entered, to said dispatching information server when a dispatchable temporary worker occurs in an organization; and
means for displaying job offer information representing the desired number of dispatched temporary workers, a desired skill thereof, and a desired dispatching period, transmitted from said dispatching information server;
said job offer terminal comprising:
means for transmitting job offer information representing the number of temporary workers desired to be dispatched, a skill thereof, and a desired dispatching period, which have been entered, to said dispatching information server when a request for a temporary worker occurs; and
means for displaying dispatchable temporary worker information transmitted from said dispatching information server;
said dispatching information server comprising:
means for registering dispatchable temporary worker information transmitted from said dispatching terminal;
means for registering job offer information transmitted from said job offer terminal;
means for searching job offer information registered therein when dispatchable temporary worker information is transmitted from said dispatching terminal, and, if there is job offer information that matches said dispatchable temporary worker information, transmitting said dispatchable temporary worker information to said job offer terminal which has registered the matching job offer information; and
means for searching dispatchable temporary worker information registered therein when job offer information is transmitted from said job offer terminal, and, if there is dispatchable temporary worker information that matches said job offer information, transmitting the matching dispatchable temporary worker information to said job offer terminal.

2. A temporary worker information management system according to claim 1, wherein a user of the temporary worker information management system registers user information in said dispatching information server, said dispatching information server comprising means for authenticating the user based on the registered user information when said dispatching information server is logged in.

3. A temporary worker information management system according to claim 1, wherein each of a temporary worker dispatcher and a temporary worker recipient pays a fixed membership fee and a predetermined ratio of a dispatching cost to an administrator of said dispatching information server.

4. A temporary worker information management system according to claim 1, wherein said dispatching terminal, said job offer terminal, and said dispatching information server are installed in a company or companies which cooperate with each other.

5. A temporary worker information management system according to claim 1, wherein said job offer terminal further comprises:
means for transmitting an entered evaluation report on an evaluation of the skill of a dispatched temporary worker to said dispatching information server;
means for transmitting an entered dispatching contract evaluation information referring request to said dispatching information server; and
means for displaying dispatching contract evaluation information transmitted from said dispatching information server;
wherein said dispatching terminal further comprises:
means for transmitting an entered dispatching contract evaluation information referring request to said dispatching information server; and
means for displaying dispatching contract evaluation information transmitted from said dispatching information server; and
wherein said dispatching information server further comprises:
means for generating dispatching contract evaluation information which reflects details of an evaluation report transmitted from said job offer terminal, registering the generated dispatching contract evaluation information therein, and transmitting the generated dispatching contract evaluation information to said dispatching terminal; and
means responsive to dispatching contract evaluation information referring requests transmitted from said dispatching terminal and said job offer terminal, for transmitting dispatching contract evaluation information registered in said dispatching information server to said dispatching terminal and said job offer terminal.

6. A temporary worker information management system according to claim 5, wherein said dispatching information server comprises means for registering user information of a user of the temporary worker information management system in advance, and authenticating the user based on the registered user information when said dispatching information server is logged in.

7. A method of managing temporary worker information of the temporary worker information management system, comprising the steps of:
transmitting dispatchable temporary worker information representing the number of dispatchable temporary workers, a skill thereof, and a dispatchable period, which have been entered, from a dispatching terminal to a dispatching information server via a network when a dispatchable temporary worker occurs in an organization;
displaying, on said dispatching terminal, job offer information representing the desired number of dispatched temporary workers, a desired skill thereof, and a desired dispatching period, transmitted from said dispatching information server via said network;
transmitting job offer information representing the number of temporary workers desired to be dispatched, a skill thereof, and a desired dispatching period, which have been entered, from a job offer terminal to said dispatching information server via said network;
displaying, on said job offer terminal, dispatchable temporary worker information transmitted from said dispatching information server via said network;
registering, in said dispatching information server, dispatchable temporary worker information transmitted from said dispatching terminal via said network;
registering, in said dispatching information server, job offer information transmitted from said job offer terminal via said network;
searching job offer information registered in said dispatching information server when dispatchable temporary worker information is transmitted from said dispatching terminal to said dispatching information server via said network, and, if there is job offer information that matches said dispatchable temporary worker information, transmitting said dispatchable temporary worker information to said job offer terminal which has registered the matching job offer information via said network; and
searching dispatchable temporary worker information registered in said dispatching information server when job offer information is transmitted from said job offer terminal to said dispatching information server, and, if there is dispatchable temporary worker information that matches said job offer information, transmitting the matching dispatchable temporary worker information to said job offer terminal via said network.

8. A method according to claim 7, wherein a user of the temporary worker information management system registers user information in said dispatching information server, further comprising the step of authenticating the user based on the registered user information when said dispatching information server is logged in.

9. A method according to claim 7, wherein each of a temporary worker dispatcher and a temporary worker recipient pays a fixed membership fee and a predetermined ratio of a dispatching cost to an administrator of said dispatching information server.

10. A method according to claim 7, wherein said dispatching terminal, said job offer terminal, and said dispatching information server are installed in a company or companies which cooperate with each other.

11. A method according to claim 7, further comprising the steps of:
transmitting an entered evaluation report on an evaluation of the skill of a dispatched temporary worker from said job offer terminal to said dispatching information server via said network;
generating dispatching contract evaluation information which reflects details of an evaluation report transmitted from said job offer terminal via said network; registering the generated dispatching contract evaluation information in said dispatching information server;
transmitting the generated dispatching contract evaluation information to said dispatching terminal via said network;
transmitting an entered dispatching contract evaluation information referring request from said job offer terminal to said dispatching information server via said network;
transmitting an entered dispatching contract evaluation information referring request from said dispatching terminal to said dispatching information server via said network;
transmitting dispatching contract evaluation information registered in said dispatching information server to said dispatching terminal and said job offer terminal via said network in response to dispatching contract evaluation information referring requests transmitted from said dispatching terminal and said job offer terminal;
displaying dispatching contract evaluation information transmitted from said dispatching information server via said network on said job offer terminal; and
displaying dispatching contract evaluation information transmitted from said dispatching information server via said network on said dispatching terminal.

12. A method according to claim 11, further comprising the steps of registering user information in said dispatching information server in advance, and authenticating a user based on the registered user information when said dispatching information server is logged in.

13. A dispatching terminal comprising:
means for transmitting dispatchable temporary worker information representing the number of dispatchable temporary workers, a skill thereof, and a dispatchable period, which have been entered, to a dispatching information server via a network when a dispatchable temporary worker occurs in an organization; and
means for displaying job offer information representing the desired number of dispatched temporary workers, a desired skill thereof, and a desired dispatching period, transmitted from said dispatching information server;

14. A job offer terminal comprising:
means for transmitting job offer information representing the number of temporary workers desired to be dispatched, a skill thereof, and a desired dispatching period, which have been entered, to a dispatching information server when a request for a temporary worker occurs; and
means for displaying dispatchable temporary worker information transmitted from said dispatching information server.

15. A dispatching information server comprising:
means for registering dispatchable temporary worker information transmitted from a dispatching terminal;
means for registering job offer information transmitted from a job offer terminal;
means for searching job offer information registered in the dispatching information server when dispatchable temporary worker information is transmitted from said dispatching terminal, and, if there is job offer information that matches said dispatchable temporary worker information, transmitting said dispatchable temporary worker information to said job offer terminal which has registered the matching job offer information; and
means for searching dispatchable temporary worker information registered in the dispatching information server when job offer information is transmitted from said job offer terminal, and, if there is dispatchable temporary worker information that matches said job offer information, transmitting the matching dispatchable temporary worker information to said job offer terminal.

16. A recording medium storing:
a program executable by a dispatching terminal computer connected to a dispatching information server computer and a job offer terminal computer via a network, for carrying out the steps of transmitting dispatchable temporary worker information representing the number of dispatchable temporary workers, a skill thereof, and a dispatchable period, which have been entered, to said dispatching information server computer when a dispatchable temporary worker occurs in an organization, and displaying job offer information representing the desired number of dispatched temporary workers, a desired skill thereof, and a desired dispatching period, transmitted from said dispatching information server computer;
a program executable by the job offer terminal computer connected to the dispatching information server computer and the dispatching terminal computer via the network, for carrying out the steps of transmitting job offer information representing the number of temporary workers desired to be dispatched, a skill thereof, and a desired dispatching period, which have been entered, to said dispatching information server computer when a request for a temporary worker occurs, and displaying dispatchable temporary worker information transmitted from said dispatching information server computer; and
a program executable by the dispatching information server computer connected to the job offer terminal computer and the dispatching terminal computer via the network, for carrying out the steps of registering dispatchable temporary worker information transmitted from said dispatching terminal computer, registering job offer information transmitted from said job offer terminal computer, searching job offer information registered in the dispatching information server computer when dispatchable temporary worker information is transmitted from said dispatching terminal computer, and, if there is job offer information that matches said dispatchable temporary worker information, transmitting said dispatchable temporary worker information to said job offer terminal computer which has registered the matching job offer information, and searching dispatchable temporary worker information registered in the dispatching information server computer when job offer information is transmitted from said job offer terminal computer, and, if there is dispatchable temporary worker information that matches said job offer information, transmitting the matching dispatchable temporary worker information to said job offer terminal computer.
